(19) United States
(12) Patent Application Publication
(10) Pub. No.: US 2004/0010550 A1
(43) Pub. Date: Jan. 15, 2004

(54) On-demand provisioning of a set of services to interconnect a group of participants

(76) Inventor: Bhaskarpillai Gopinath, Los Angeles, CA (US)

Correspondence Address: John T Peoples, 14 Blue Jay Court, Warren, NJ, 07059, US

(21) Appl. No.: 10/619,245

(22) Filed: Jul. 14, 2003

Related U.S. Application Data
(63) Continuation of application No. 09/360,057, filed on Jul. 23, 1999, now abandoned.

(51) Int. Cl. G06F 15/16

(52) U.S. Cl. 709/205

(57) ABSTRACT

Techniques for enabling existing and new services and for configuring one or more of the services to instantiate an application which is readily accessible to a dynamically-formed group of interested participants at the appointed time for a desired duration are disclosed.

### CROSS-REFERENCE TO A RELATED APPLICATION

This application is a continuation of the application having Ser. No. 09/360,057 filed Jul. 23, 1999.

### BACKGROUND OF THE DISCLOSURE

1. Field of the Invention

This invention relates to computer network-implemented services and, more particularly, to the dynamic configuration of a set of the services into an application accessible to a group of interested participants.

2. Description of the Background Art

Traditionally, user access to and interaction with the Internet is site-specific, that is, a user accesses the Internet via a Uniform Resource Locator (URL) which identifies a given website page and facilitates access to the website. As an example, suppose a user, from their PC, connects to the Internet through their Internet Service Provider (ISP) to access the given home page via the URL “www.givenhomepage.com” (generally referred to as the Internet website). Once connected to this home page, the user may be provided with direct textual information, or the user may navigate to other websites using URL links posted on the home page. In addition, the user may request the downloading of information accessible via the home page by selecting a link to that information. The information may be in textual, audio and/or video format. To view or listen to the information, it may be necessary for the user to first download a “plug-in” which interprets and formats the information for display or playback to the user. Thus, from the user's viewpoint, the user only accesses predetermined features of the home page, and has virtually no control in setting up the types of features that the given home page provides to users of the home page.

Of course, it is possible for each user to set up their own home page, and in the process of doing so, the user may configure this personal home page according to the desires of the user and/or the purpose of the home page. However, many users may not be sufficiently versed in the Internet to set up their own home page and so this is not a reasonable option. Moreover, even if the user sets up their own home page, it is usually generic in the sense that it is not tailored to specific occasions or activities. For example, as set forth in some detail below, suppose a user desires to establish a temporary home page to celebrate the birthday of a family member or friend. The tools available to the user in establishing this home page for the “birthday occasion” are very limited at best, and the art is certainly devoid of both tools and concomitant procedures to establish a temporary website that is occasion-specific, in contrast to the typical site-specific nature of the conventional Internet. Even where some tools may exist (e.g., a “birthday card” website), it is a formidable if not virtually impossible task for the user to import these intricacies of other website links into the user's home page. In addition, there are other interfaces that a typical user cannot design, such as interfaces to stores or credit card companies. Thus, programs connected to other suppliers' sites are needed which are of the nature of built-in interfaces. Also, programs to assist automation of the activities related to the birthday occasion are needed, and the development of such programs are usually beyond the abilities of an average user of the Internet. Moreover, the onus is upon the user to inform others that may have an interest in the specific occasion of the information necessary to access the site-specific website.

To understand these limitations of the traditional approach in the site-specific utilization of the Internet, consider the following enhanced services (heretofore unavailable) to Internet users. Suppose a user, called the “host” so as to distinguish this user from other participants to be introduced later, desires to establish a temporary, occasion-specific website to celebrate the birthday of an individual called the “celebrant”. The host communicates with a “service-provider” of services to be made available over the temporary website, which services will be described in the sequel. The host may contact the service-provider via a number of alternative communication paths, including a telephone call, fax, e-mail, or the Internet itself. For the sake of specificity, suppose the host initiates contact with the service-provider over the Internet via a URL called “www.siteforus.com”, which is the actual URL for the service-provider of the group-specific services. The service-provider responds to the host, for example, by presenting an on-line form (or more generally, a hierarchy or menu of forms) to be filled in by host; the form addresses the specific desires of the host in setting up the temporary website, which again for the sake of specificity is now designated “www.siteforus.com/host1”. Other modes of interaction with the host are also possible, such as speech recognition and interactive voice response.

For this example, the host indicates that a birthday occasion is to be celebrated, and when the celebration is to occur, that is, the date and time period for the celebration (e.g., May 31 starting at 5:00 PM until June 1 at 3:00 PM). In addition, the host provides the names and access information for those participants that the host wishes to “invite” to the birthday celebration; these participants are called “group members”, with the host and celebrant automatically included as group members. (Later, the notion of participants is generalized so that there are both human participants as well as non-human entities, such as memory or programs, which may be participants in the birthday celebration.) The access information might be the Internet home page of each group member having a home page, or the telephone numbers, or the fax numbers, or the e-mail addresses of the group members so the group members may be invited to the celebration using the access information.

The host can then select the types of services desired for the celebration from a menu list. For instance, the menu items may include: (1) a “birthday card” so that the group members may select from a list of available birthday cards and then post a birthday card which can be accessed and viewed by celebrant on the occasion-specific sight “www.siteforus.com/host1”; (2) a “song list” which may be played for the celebrant via an Internet audio player when accessed by the celebrant; (3) a “bulletin board” to post birthday greetings by the group members; (4) a “gift list” and/or “gift registry” so any group member may order a gift for the celebrant, whereupon the gift may be sent via regular mail or a special mail service to the celebrant; (5) “video clips” of special import to a birthday celebrant; and (6) the provisioning of teleconferencing connection, to be established at a given date and time (e.g., May 31 at 6:00 PM), so any group members desiring to participate may partake of the teleconference connection. A key component of the inventive system is that there is intelligence at the website to orchestrate the presentation of items such as items (1)-(6).

The service-provider generates a summary for review of the desired services that have been selected by the host, and communicates this summary to the host via, for instance, an Internet message, an e-mail message or a fax. Upon modification, if any, and confirmation by the host, the service-provider then initiates the scheduling of the services as selected by the host in concert with the time period chosen by the host, and notifies the group members via the access information of each member as to the time of the celebration, as well as the “www.siteforus.com/host1” URL to participate in the celebration and/or the teleconferencing time and number. As an added feature, it may be desirable to have the celebration “private”, so the information provided to the group members may include a code/personal identification number (PIN) to access “www.siteforus.com/host1”.

The service-provider is arranged with software and hardware so as to dynamically configure the set of services to interact with the group members. The set of services for a given occasion, from the point of view of the service-provider, is referred to as an application. It is clear, for example, that two applications may have the same services, but each application may differ because, for instance, the group members are not the same, or the date and/or time interval is different.

An exemplary list of hardware includes: (i) immediately accessible storage for text of birthday greetings, voice, video; (ii) teleconferencing bridge; (iii) archival storage for later recall of the interactions on the temporary website. An exemplary list of software includes: (a) programs to support interaction with the host, such as presentation of the on-line form, and summary presentation of the form to the host; (b) programs for notifying the group members of the group activity; (c) programs to track activity usage for billing purposes; (d) programs for on-line help accessible by all group members; (e) programs to support and coordinate the birthday activities selected the host (e.g., birthday cards, gift list, song list, bulletin board, audio/video, teleconferencing); (f) programs to transact business with suppliers and agencies, and so forth; and (g) a program manager to manage all software and hardware interactions.

Besides the “birthday” occasion, it is readily contemplated that other special occasions may be patterned after this particular occasion; such other occasions include: holidays; weddings; anniversaries; graduations; and class reunions. Besides this special-occasion category, it is easily contemplated that other types of applications can be implemented in an analogous manner, including: (a) business activities such as “deal-making” meetings; (b) customer care such as disaster recovery from a virus attack; (c) advertising to targeted groups; and (d) travelogues in video/slide format. The applications engendered by the model in accordance with the present invention are essentially limitless.

Thus, the art is devoid of computer network-implemented, service-specific interactions among group members having a community of interest, so a definite need exists in the art for configuring, on-demand, a set of services to form an application. Such an application must be readily accessible to a group of interested participants at the appointed time for a duration controlled by the participants, as well as a mechanism to preserve information interchanged by the participants which may be recalled at a later time, that is, the application exhibits “persistence”. An illustrative example of such an on-demand application is configuring services accessible via the Internet to connect the group of interested participants. Moreover, the art does not teach or suggest any techniques to manage dynamically-formed groups that are brought together from static groups and who are linked for a transitory time in a given activity.

### SUMMARY OF THE INVENTION

These shortcomings and other limitations and deficiencies are obviated in accordance with the present invention by enabling existing and new services and by dynamically configuring one or more of the services to instantiate an application which is readily accessible to a group of interested participants at the appointed time for a desired duration, as heretofore not contemplated.

In accordance with one broad aspect of the present invention, a method for servicing a group of participants includes: (a) the generation of a set of computer network-implemented services available from a service provider; and (b) the dynamic configuration by the service provider, as controlled by at least one of the participants or upon default, an application composed of selected ones of the services for interconnecting the group of participants.

In accordance with another broad aspect of the present invention, a method for managing an activity effected by a plurality of groups which are dynamically linked for the duration of the activity includes: (a) coordinating interactions carried out by the dynamically linked groups for duration of the activity; and (b) capturing information representative of the interactions of the dynamically linked groups during the period of the activity for later retrieval and use.

In accordance with still another broad aspect of the present invention, a method for managing an activity includes: (a) generating a thread for the activity which is, in combination, a name for an activity and a dynamically-formed group of participants; and (b) providing services through servers to instantiate an application corresponding to the thread.

In accordance with yet another broad aspect of the present invention, a method for serving two parties with an interconnection server composed of an interconnection interface for establishing a telephone call between the parties and a memory sub-space assigned to each of the parties includes: (a) connecting said one party to said one party's corresponding sub-space for storing or retrieving information in response to a telephone call initiated by a first one of the parties; and (b) in response to said one party providing the calling number of a second one of the parties, establishing a telephone connection between the parties via the interconnection interface.

### BRIEF DESCRIPTION OF THE DRAWINGS

The teachings of the present invention can be readily understood by considering the following detailed description in conjunction with the accompanying drawings, in which:

FIG. 1 illustrates a high-level block diagram of a system for provisioning an application from a set of services of interest to a community of users as controlled by the application server;

FIG. 2 is representative of the form to be filled in on-line to request an occasion-specific application;

FIG. 3 is a structure chart of the programs controlled by the site manager to compile an instance of an application;

FIG. 4 is a structure chart of the services that are application-independent and which are bound, with information provided in each instance, to generate an instance of an application;

FIG. 5 illustrates the composition of two applications, which may bind the same services, but which differ because of occasion-specific information;

FIG. 6 is a high-level block diagram of hardware components that comprise the occasion-specific system of FIG. 1;

FIG. 7 is a flow diagram for establishing an occasion-specific application as manifested by an activity requested by a given user;

FIG. 8 depicts the components for a teleconference call overlaid on FIG. 1;

FIG. 9 is a high-level flow diagram for a dynamically-formed group activity;

FIG. 10 depicts additional steps augmenting the flow diagram of FIG. 10; and

FIG. 11 depicts an illustrative embodiment of an interconnection server to support and track an activity established on-demand by a requesting party.

To facilitate understanding, identical reference numerals have been used, where possible, to designate identical elements that are common to the figures.

### DETAILED DESCRIPTION

After considering the following description, those skilled in the art will clearly realize that the teachings of my invention can be readily utilized in configuring, on-demand, a set of services to form an application which is readily accessible to a group of interested participants at the appointed time for a desired duration.

### Overview of the Present Invention

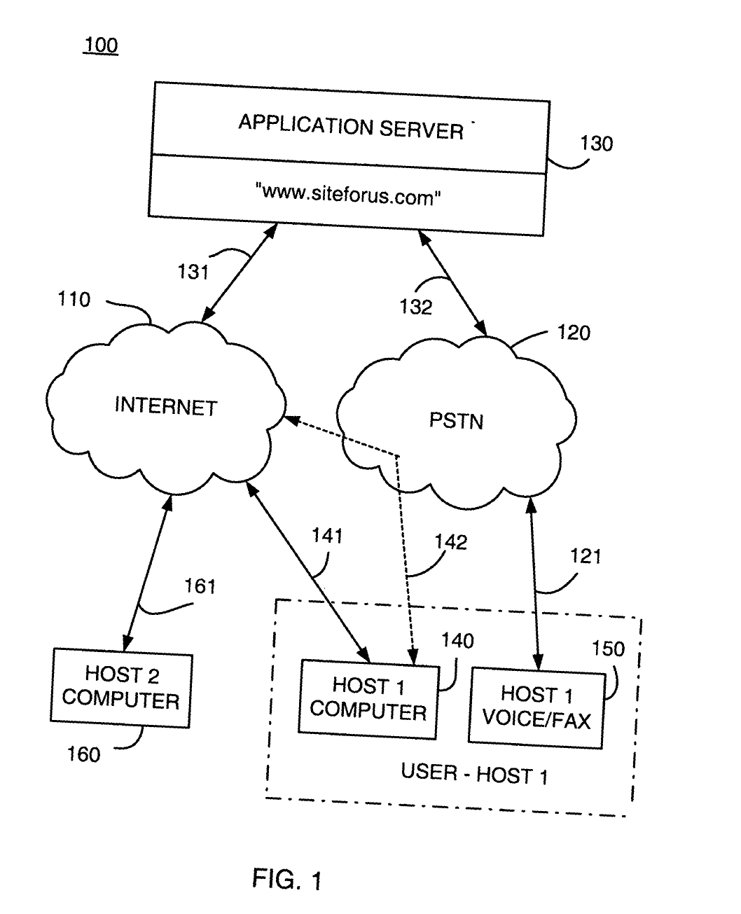

This section describes system 100 of FIG. 1 in overview fashion so as to introduce the technological environment of one illustrative embodiment in which the present invention operates, as well as to introduce terminology helpful in further describing the details—both hardware components and system software—which follow in the sequel. For purposes of specificity, but not by way of limitation, system 100 is illustrated as operating in the Internet environment with only a single server, and initially elucidates the set of services embodied in the “birthday” occasion as discussed in some detail in the Background Section. Later, generalizations are presented to encompass the broad nature of the present inventive subject matter.

With reference to FIG. 1, system 100 illustratively includes: (a) conventional Internet network 110; (b) conventional Public Service Telephone Network (PSTN) 120; (c) application server 130 identified by the URL which provides occasion-specific services (example URLs are “www.siteforus.com” or “www.siteforme.com”) coupled to Internet 110 and PSTN 120 via paths 131 and 132, respectively; (d) personal computer 140 by which a user, designated Host1, accesses server 130 via Internet network 110 or PSTN 120 via path 121; and (e) access device 150 (e.g., telephone or fax machine) for which Host1 interconnects to PSTN 120. Host1 may connect to Internet 110 via a direct, on-line path, designated 141, or indirectly via a dial-up connection path 142 (shown dashed) through PSTN 120 to Internet 110.

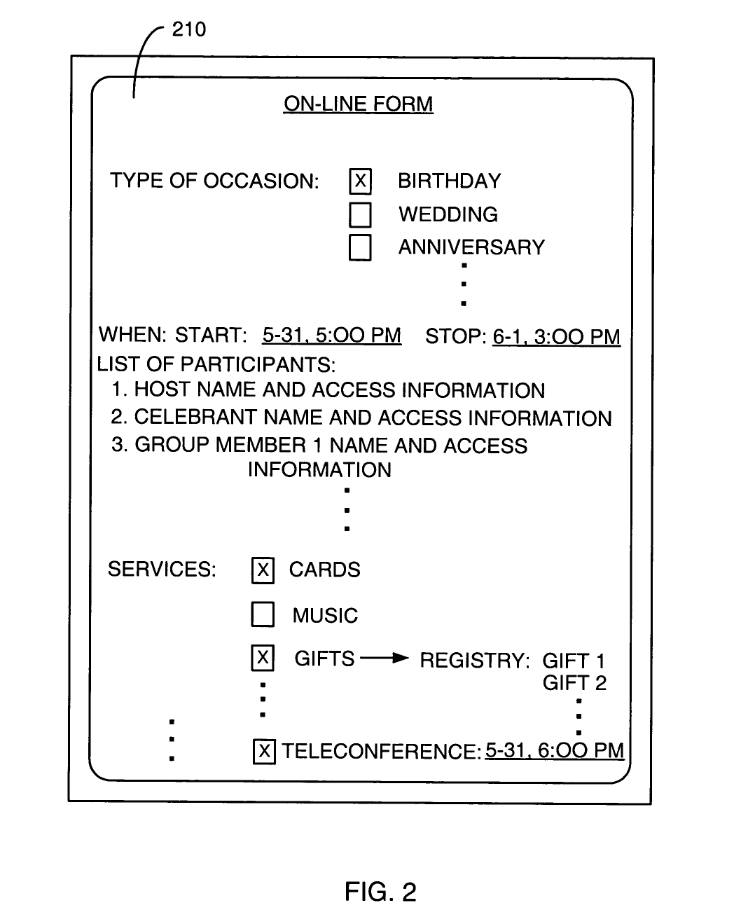

As outlined in the Background, suppose Host1 desires to establish a “birthday” occasion temporary website. Host1 accesses server 130 via its URL, and server 130 responds by providing a form (or generally, a menu of forms) to be filled-in by Host1 to effect birthday occasion services composing a given application. A representative on-line form 210 is shown in FIG. 2, wherein certain information is to be provided by Host1. In this instance, Host1 has X-marked a “birthday” occasion. In addition, the interval over which the temporary website is to be instantiated is shown by the Start-Stop dates and times. Next, the list of group members, with access information, is depicted. Finally, the desired services are selected by X-marking the menu list. As also depicted, other necessary information is filled in by Host1, such as a listing of gift suggestions (e.g., “gift1”, “gift2”) and the specific date and time information regarding a teleconference call to celebrate with the “celebrant” of the birthday. After confirmation that the information provided by Host1 is correct, server 130 initiates the provisioning of the application (called Application1) to handle this instantiation of the set of selected services. The procedure for compiling Application1 is detailed shortly.

It is further understood, in view of the broad aspect of the present invention, that information from a previous birthday occasion may have been preserved, that is, saved in a storage location for later recall by Host1 or other participants that may desire to recall the information; this aspect of the invention is known as “persistence” and is manifested by each instantiated application having the functionality to save, store, and recall historical information about the past occasions. Accordingly, it may only be necessary to change the age of the Celebrant, and the remaining information may carried over to the new birthday. It is also possible, for example, because of the persistence of the application, to enable the application to automatically follow-up with Host1 the following year to determine whether or not Host1 desires to celebrate the present birthday. If so, the saved information can be presented to Host1, and modified as needed. Host1 may direct the application to contact another former participant, or a new participant, that might host this year's birthday occasion.

System Software

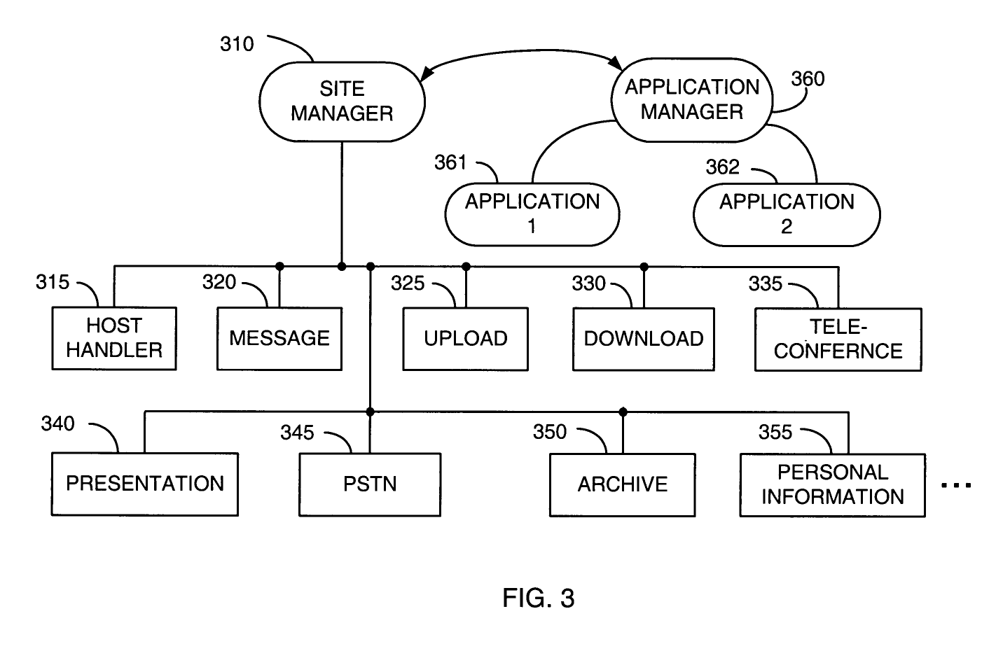

With reference to FIG. 3, there is shown site manager 310 which is resident and executing on server 130, along with the set of programs 315-355 to handle configuration of each application. Site manager 310 controls: (a) host handler 315 which interacts with Host1 to establish the set of desired services—handler 315 provides the form(s) to be filled-in as well as the message interchanges with Host1; (b) message handler 320 which completes the task of informing the group members of the details of the particular application, of which Application1 is exemplary, such as the URL to access the special occasion or the teleconference number; (c) upload handler 325 for receiving uploaded information from group members, such as a RSVP as to whether or not a particular group member will be available to participate in the special occasion, as well as text, audio, or video which a group member wishes to present to the celebrant; (d) download handler 320 for interacting with group members, such as by providing “plug-ins” to group members or text, audio, or video streaming to group members if the group members do not have such plug-ins; (e) teleconference manager 325 which arranges for a teleconference call at the appointed time and date; (f) presentation manager 340 which provides tools useable by group members to enhance their ability to interact with the other services; examples include a “drawing” tool or a “word” processing tool; (g) PSTN 345 interface for interconnecting to PSTN 120; (h) archive manager 350 to capture and archive the information interchanges occurring during the existence of the temporary website; and (h) personal information manager 355 which allows each group member access to certain personalized information of the particular group member at their request—this functionality, which has not been introduced earlier, will be elaborated upon shortly. Some or all of programs 315-355 may be bound together to form the application for the specific occasion. The particular binding of the requisite programs results in the instantiation of a particular application (e.g., Application1) shown as being handled by application manger 360 which is coupled to site manager 310. Application manger 360 off-loads site manager 360 once an application has been created. Application manager 360 is shown as managing Application1 361 as set up by Host1.

Again with reference to FIG. 1, there is shown a second host, namely, Host2, who also accesses application server 130 via Host2's computer 160 over path 161 (perhaps concurrently with Host1). Once it is determined that Host2 also desires to set-up an occasion-specific website, site manager 310 of FIG. 3 instantiates another application (Application2) to handle Host2's selection of specific services. This instance is shown as Application2 362 in FIG. 3, which is coupled with Host2. Whereas the site assigned in the former case may be, for example, “www.siteforus.com/Host1”, the site in the latter case is, analogously, “www.siteforus.com/Host2”.

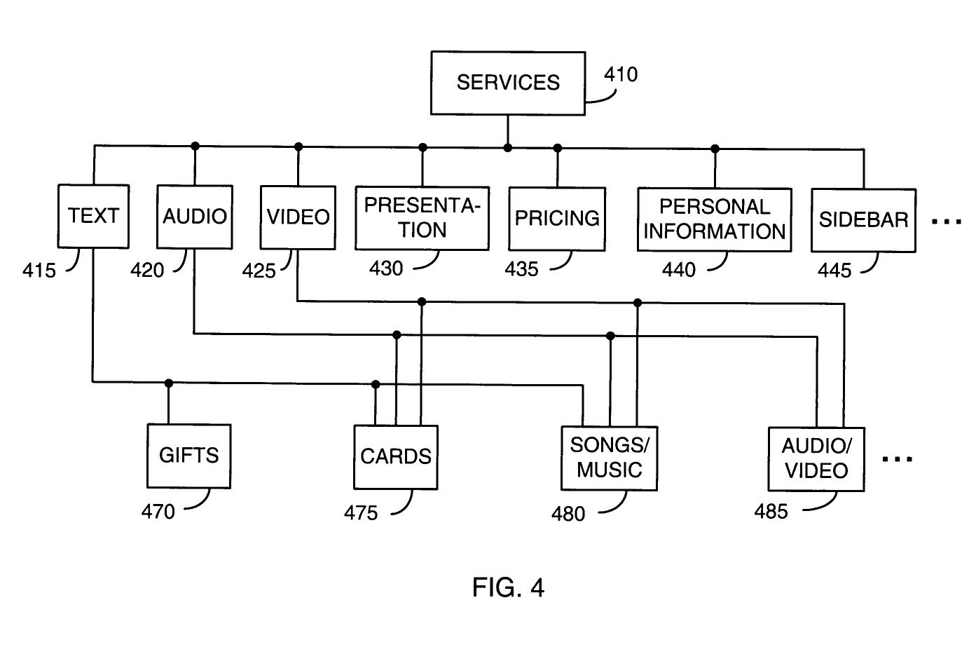

From another viewpoint, site manager 310 handles a number of requested services via programs 315-355 of FIG. 3 to instantiate a given application, that is, an application is composed of a set of generic services which can be dynamically provisioned by application server 130 under control of site manager 310 to create each application. Now with reference to FIG. 4, an exemplary set 410 of services is shown. The host, as alluded to above, can select from such services as text service 415, audio service 420, video service 425, presentation service 430, pricing service 435, personal information service 440, and “sidebar” service 445 which will be described in more detail below. Services 415-445 may be described by their “features” which are applicable to all applications. Features or combinations of features may further engender instances of services, some of which include “gift” service 470, “greeting card” service 475, “song/music” service 480, “audio/visual” service 485, and so forth.

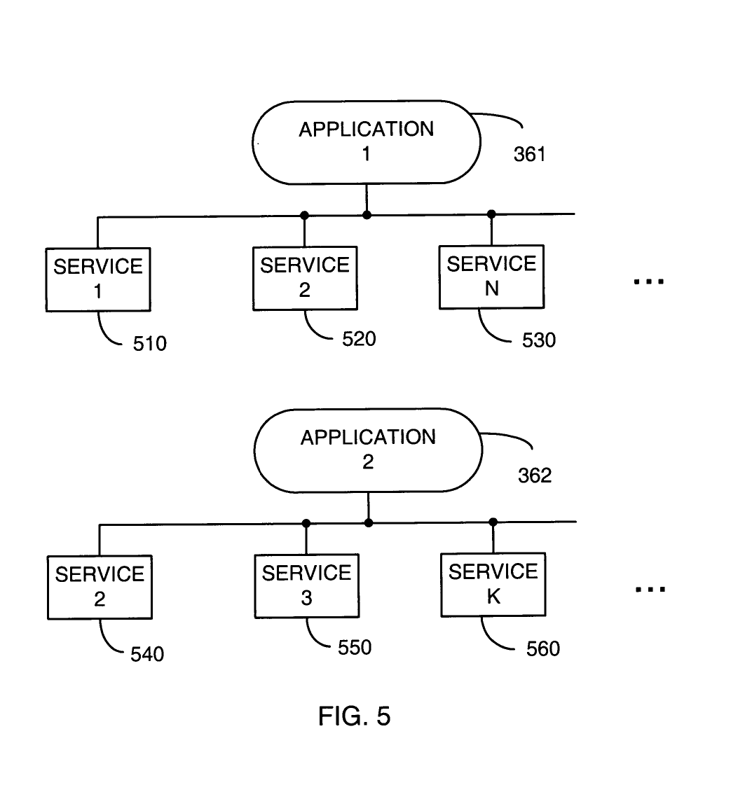

Referring now to FIG. 5, there is depicted the manner in which applications are instantiated from the services of FIG. 4. In particular, Application1 361 may be composed of a set of services 510-530, namely, Service1, Service2, and Service N. Similarly, Application2 362 may be composed of a set of services 540-560, namely, Service 2, Service3, and Service K. It is equally clear that applications 361 and 362 may be instantiation of the same services, but they differ because of specific information pertaining to, for instance, time, date, and/or group members.

System Hardware

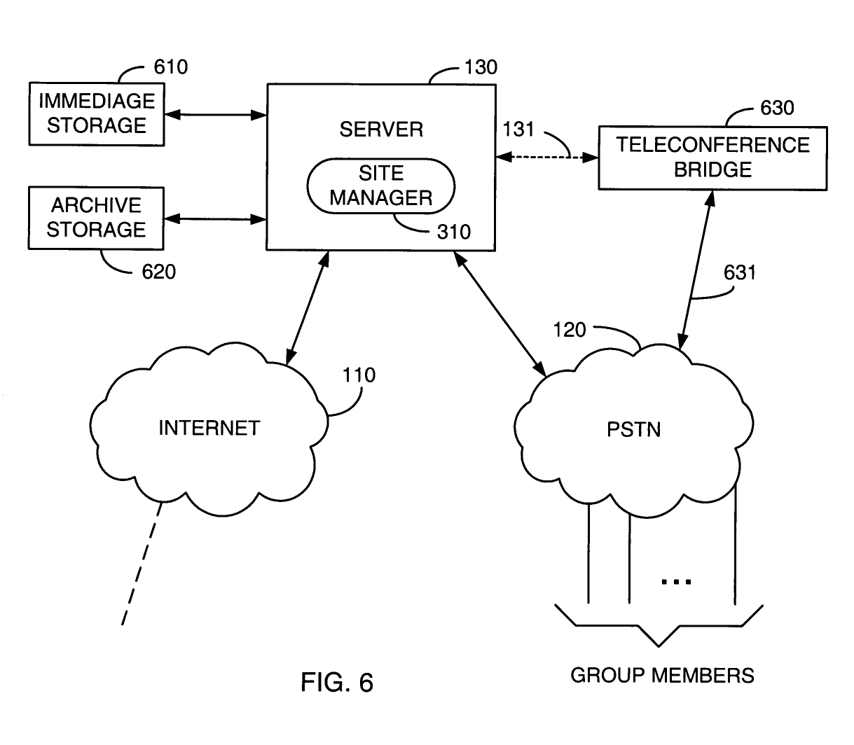

With reference to FIG. 6, there are shown block diagrams of hardware components which augment application server 130 in the provision of applications. In particular, the components include: “immediate” storage device 610 which is used to store the instance of each application prior to execution, along with data produced during execution of each application, such as billing information; archive storage device 620 which stores the instance of the application upon removal of the temporary website; and teleconferencing bridge 630 which is used to interconnect the group members who participate in a given teleconference. Server 130 controls access to and/or execution of the hardware components 610-630 via the instances of the applications (e.g., applications 361 and 362 of FIG. 3).

It is noted that teleconferencing bridge 630 also couples to PSTN 120 since bridge 630, interconnection path 631 and PSTN 120 are actually the physical paths over which the teleconference takes place. Server 130 allocates, at the time reserved for the teleconference desired by an application, one of a plurality of conferencing bridges, with bridge 630 being exemplary. Group members access bridge 630 via PSTN 120 and interconnection path 631.

Flow Diagram

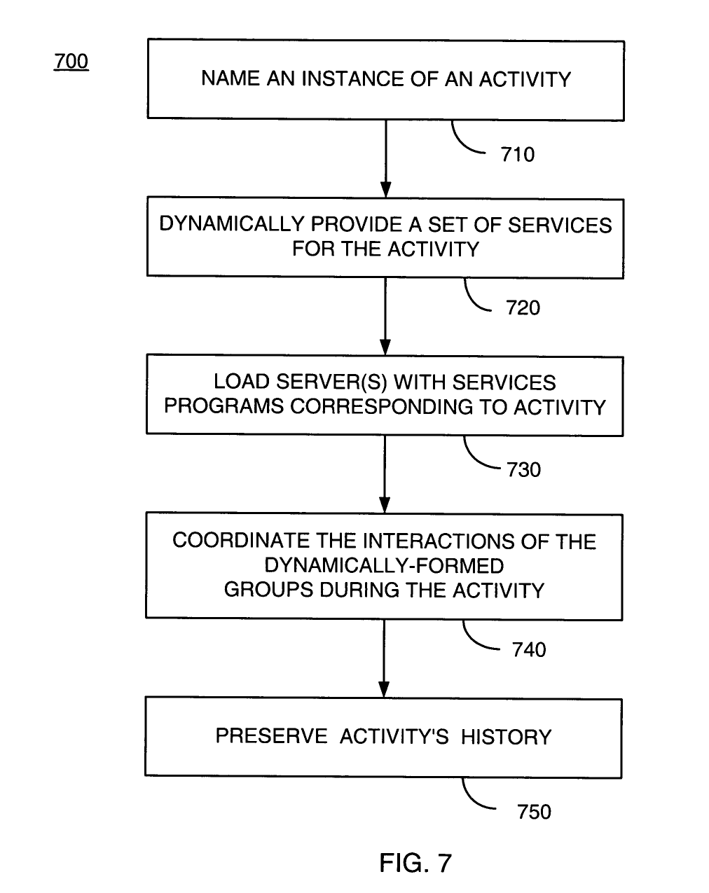

Referring now to FIG. 7, there is shown flow diagram 700 which illustrates the processing effected by the methodology in accordance with the present invention. In particular, processing block 710 is invoked to name an instance of an activity, such as a birthday occasion hosted by Host1. Next, block 720 is executed to dynamically provide a set of services for the activity which are bound into a specific application (e.g., Application1). Then, processing by block 730 is carried out so actually load server 130 with the programs for the services, that is, the executable code that will operate Application1. Processing by block 740 is then invoked so that the interactions of the group activity are effectively and efficiently coordinated. Finally, historical information about the activity is preserved by processing block 750.

Enhancements and Refinements to the System

Other URL sites can be reserved for specific occasions rather than using a sub-site; for example, “www.kensbirthday.com” can be assigned in place of “www.siteforus.com/Host1”.

1.) System Structure

In FIG. 1, application server 130 has been shown as the single interface to users (Host1 and/or Host2). It is readily contemplated that other arrangements may be configured to carry out the desired functionality of the application server. For instance, there may be a plurality of networked computers, called service providers, that collectively effect the server functionality. Such computers may be peer-to-peer, or have a master-slave relationship. Thus, in FIG. 3, site manager 310 may be software distributed over the plurality of computers, and the coordination may be accomplished by any well-known concurrency control which synchronizes computer interactions. Moreover, as alluded to by FIG. 3, application manager 360 may also be executed on an arrangement of distributed computers referred to as service implementers. Again, concurrency is accomplished by well-known techniques.

Moreover, although the illustrative embodiment has been couched in terms of the Internet, it is clear that a general computer network implementation imbued with the structure and characteristics heretofore described can effect the applications in accordance with the present invention. For instance, an intelligent communications network can carry out the techniques of the present invention; an example of a network is an intelligent switch in the telephony network.

2.) Telephone Conference Connection to an Application

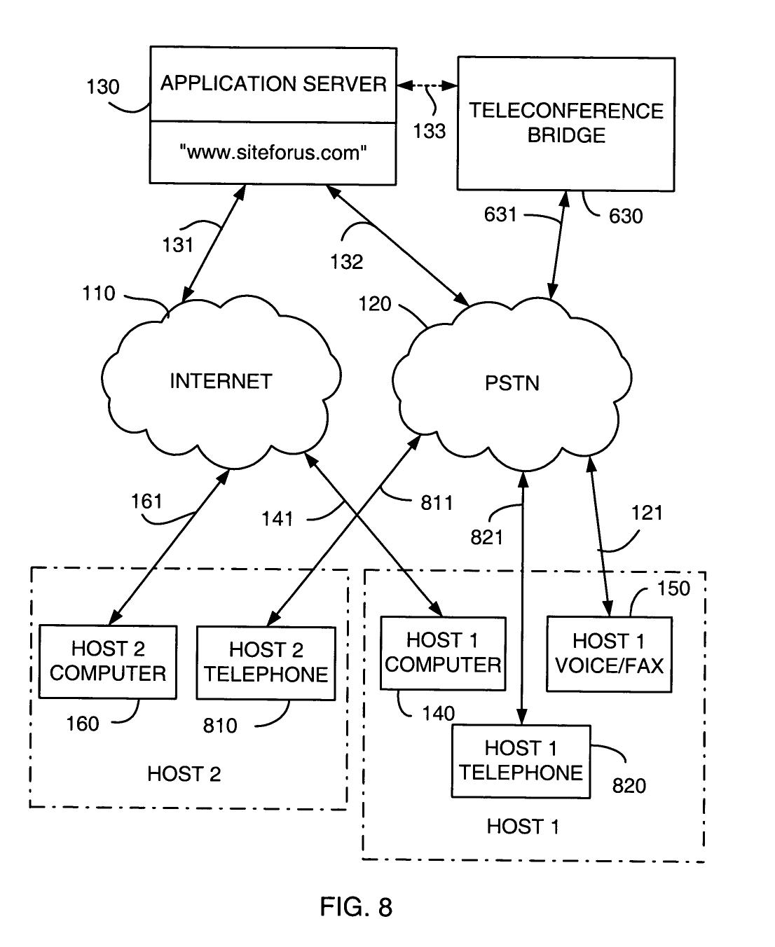

As already alluded to, an important adjunct to the application server system of FIG. 1 is the teleconference arrangement described with respect to FIG. 6. A more detailed teleconference arrangement is shown in FIG. 8, which combines the elements of FIG. 1 and FIG. 6 pertinent to the teleconference arrangement, and also depicts that each user has available a telephone for joining the teleconference, namely, Host1 has telephone 820 for accessing PSTN 120 via path 812, whereas Host2 has telephone 810 for accessing PSTN 120 via path 811. With the arrangement of FIG. 8 and the service as provided by any application (e.g., Application1), it is possible to connect to an application via a teleconference service such that the same assigned number is dialed to access the teleconference for the duration of the application.

3.) “Sidebar/Huddle” Task

Certain types of group interactions may require that some sub-set of the group be able to carry on private discussions which are not to be “overheard” or divulged to others of the group. It is possible to then configure server 130 with the capability to handle so-called “side-bar” or “huddle” discussions. Another type of service would be appended to the services already shown in FIG. 3; for the sake of discussion, this added service is called the “side-bar” service. Application manager 362, for example, is arranged with a memory space that is has a private sub-space for the sub-set of group participants requesting a “side-bar” service so that any one from the sub-set allowed access to this sub-space may deposit messages for other participants of the sub-set to review.

4.) Provision for Accompanying Music

It is further contemplated that certain occasions may be enhanced by providing “sing-along” music for the participants. It is possible to then configure server 130 with the capability to provide audio background for the sing-along activity. Yet another type of service would be appended to the services already shown in FIG. 3; for the sake of discussion, this added service is called the “sing-along” service. Application manager 362, for example, is arranged with an audio capability, including stored music, that can be “audio-streamed” to those celebrants/participants having appropriate website capabilities for receiving audio streaming.

5.) Picture/Slide Presentation or Video-Recorded Events

It is further contemplated that certain occasions may be enhanced by providing video and/or slide presentations for the participants. It is possible to then configure server 130 with the capability to provide video capability to support this activity. Still another type of service would be appended to the services already shown in FIG. 3; for the sake of discussion, this added service is called the “video” service. Application manager 362, for example, is arranged with an video capability to store uploaded video, that can be “video-streamed” to those celebrants/participants having appropriate website capabilities for receiving video streaming.

6.) Other Occasions/Themes/Activities

It view of the foregoing detailed discussion, it is readily contemplated that other applications, such as occasions/themes/activities (e.g., weddings, business, customer care) can be straight-forwardly realized from the embodiments presented in the foregoing sections. Services pertinent to these other applications are designed and programmed, and then made available for assembly into the relevant applications. The services of FIG. 3 are generic, and these services can be augmented with other special services (e.g., as above, the “video” and/or “audio” services or the “side-bar” service) so as to realize the desired applications.

Generalizations to the System

1.) Activity Manager

Internet websites are utilized by people, agencies, companies, and other entities that are generically referred to as groups. Today there are personal information managers (e.g., Palm Top) dedicated to an individual in the group, and group information managers (e.g., Outlook by Microsoft) dedicated to the group of individuals, but there does not exist an “activity manager” for a particular activity accomplished by a plurality of dynamically-formed groups. So, while there may be a group information manager for Group1 and a group information manager for Group2, if one person from Group1 and one person from Group2 interact in an activity, presently there is no technique to control, manage, and preserve information produced during the activity. Very often, it may be desirable to render present or future decisions upon the activity of a member of the group based upon the on-going or prior activity, and not upon the mere membership status of an individual in the group.

In accordance with a broad aspect of the present invention, when subsets of the groups are linked together in an activity, the interaction is such that a “thread of activity” is captured by an activity manager in a website that is outside of the group; here the thread of activity means that information about the interaction is stored in a manner that it may be retrieved and used, either during the activity or at a time after the activity terminates, under control of the activity manager. For example, Group1 and Group2 may each have a website and each group can readily store, retrieve, and use information about their own actions on their website; however, if Group1 and Group2 are dynamically linked for an occasion, the role of the activity manager is to control and remember the interactions between Group1 and Group2. In effect, the activity manager supports a dynamically-formed application composed of static sets of subgroups that interact for some duration. In concrete terms, suppose Group1 is a first law firm and Group2 is a second law firm, and the activity is engendered by certain members of each firm coming together over the Internet to negotiate a particular contract. The activity manager coordinates the interaction of the parties and captures the historical sequence of events occurring during the negotiation, such as drafts of the contract, oral discussions between the parties, memos about the issues, as well as dates and times of attendance by individuals at the meetings. Thus, generally, an activity manager manages the information needs of the dynamically-formed group during the ephemeral existence of the group.

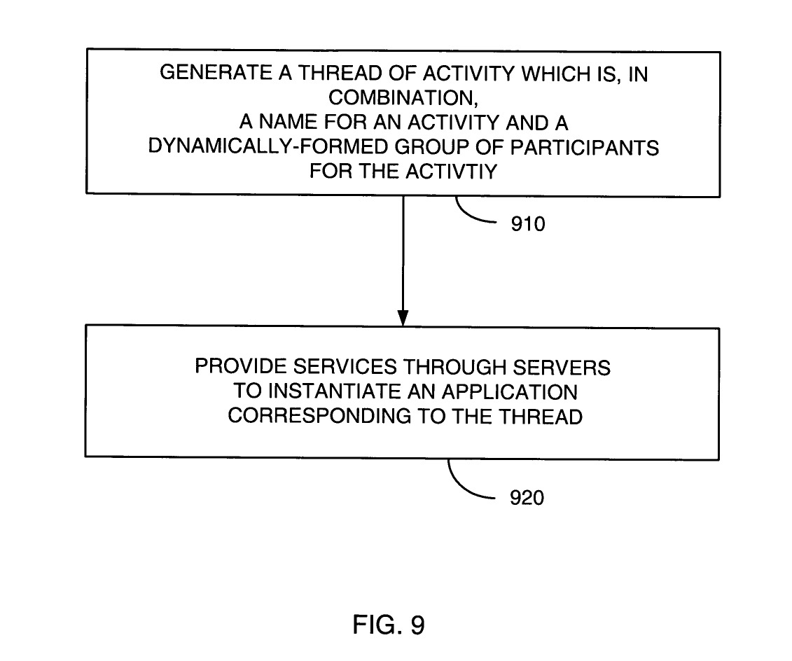

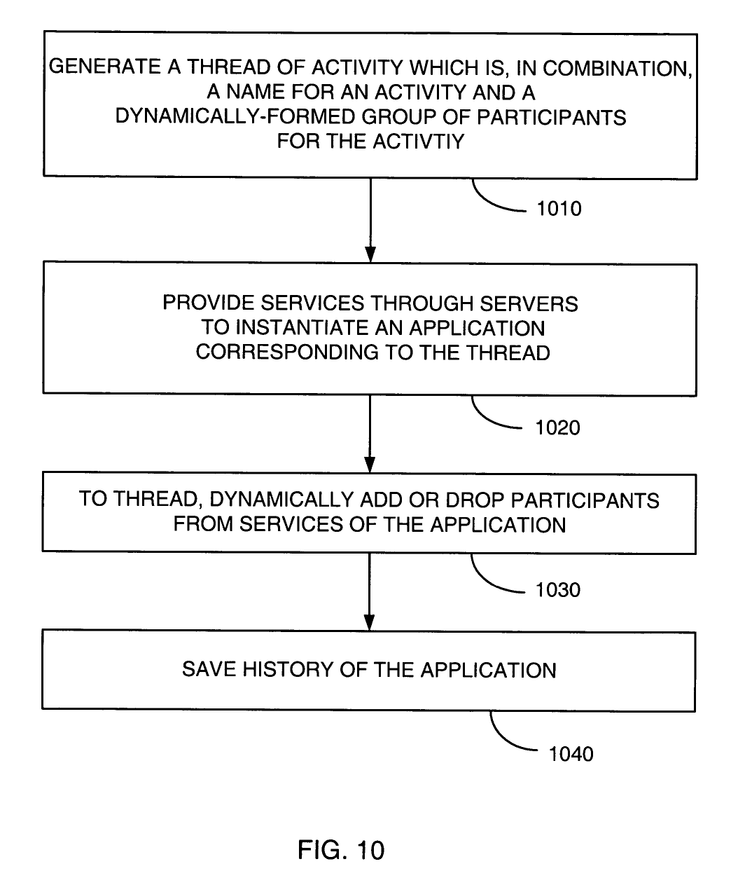

Using the foregoing discussion as a point of reference, a high-level process for managing an activity may be described as follows with reference to FIG. 9. First, processing block 910 is executed to generate a thread of activity which is, in combination, a name for an activity and a dynamically-formed group of participants. Then, processing block 920 is invoked to provide services through servers to instantiate an application corresponding to this thread. Other process steps may augment the fundamental process flow, and these steps are shown in FIG. 10. In particular, processing blocks 910 and 920 are repeated as processing blocks 1010 and 1020, respectively, in FIG. 10. Processing block 1030 is invoked to dynamically add or drop participants from services in the application for the given thread of activity. Moreover, as per processing block 1040, the history of the application is saved or preserved for later recall.

It is clear that the provision of services, as per processing block 920, can be effected either in an arrangement of servers that are either peer-to-peer or in a master-slave relationship, wherein conventional concurrency control is used to synchronize the servers in the peer-to-peer arrangement.

2.) Personal Information Manager

A personal information manager has been alluded to in sub-section (1) above when the activity manager was discussed. Wherein in conventional use a personal information manager is considered as localized to an individual having control over the personal information manager, it is possible to configure the activity manager with a personal information manager functionality. For instance, in the case of the two law firms being dynamically configured for negotiating a contract, it is possible that an individual (called Member1) may be concurrently involved in many different contracts with a number of different law firms under control of corresponding activity managers. It is advantageous for Member1 to access a personal information subspace which is also controlled by each activity manager so that, for instance, Member1 may store private/personal notes about the particular contract controlled by the activity manager. To do this, Member1 utilizes a interconnection path (which may be either a real physical channel or a logical channel such as channel 141 of FIG. 1) for private interactions with the activity manager embodied in an application server (e.g., Application1).

3.) Interconnection Service

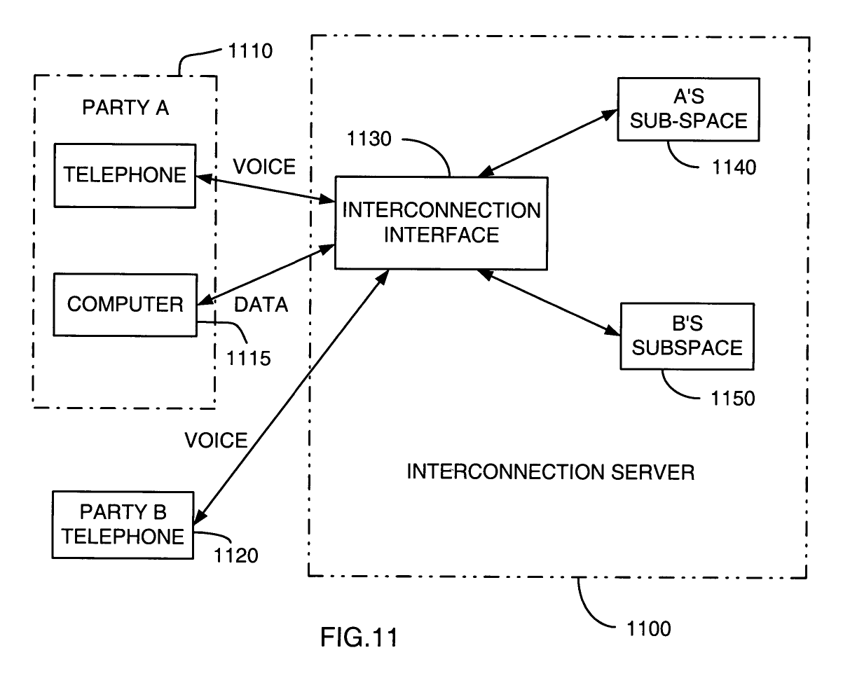

By way of further generalizing the subject matter in accordance with the present invention, reference is made to FIG. 11, wherein interconnection server 1100 is arranged to interconnect two parties on, for example, a voice call. In particular, suppose party A (reference numeral 1110) initiates a call to party B (reference numeral 1120) via a telephone number assigned to interconnection server 1100. Interconnection interface 1130 detects the incoming call from party A and answers the call. Party A is then prompted to supply a telephone number of the called party, that is, party B in this case. Presuming this is the first time calling party A calls called party B, two memory areas or sub-spaces controlled by interconnection interface 1130 are reserved, namely, A's subspace 1140 and B's sub-space 1150. These sub-spaces are private to the corresponding party so, for example, only party A can access sub-space 1140. Before server 1100 initiates an outgoing call to party B, it is possible for A to access A's sub-space 1140, via a signal from the telephone being used by party A, to leave a voice message in the subspace; this message might, for example, summarize the purpose for which A is placing the call, such as to discuss a business matter or a social engagement. A's voice message may be processed by a voice recognition device (not shown) assigned to A for the duration of the call to convert the voice message to digital form for storage in A's subspace 1140. Only after A has prompted interconnection interface 1130 does 1130 attempt to establish a connection with party B. The parties carry on their conversation under control on interface 1130. Once the conversation is ended, it is possible for each party to access their private sub-space to deposit appropriate messages, such as the points discussed during the conversation so as to memorialize the conversation for later recall as desired. Once both parties complete access to their respective sub-spaces, interconnection server 1100 terminates the established path to each party.

The recall information in either party's sub-space, it is possible for the party to complete either a telephone call to interconnection server 1100 or to log-into server 1100 using, for example, a personal computer. In concrete terms, it is supposed that party A desires to recall information in their sub-space 1140 at a later time. Party A logs into interconnection interface 1130 via A's computer 1115 and signals interface 1130 that a “sub-space review session” is desired. Interface 1130 arranges for A's access to A's sub-space 1140.

Thus, to reiterate, interconnection server 1100 is arranged to support and track an activity between parties, including the provisioning of memory (e.g., sub-spaces 1140 and 1150) for the activity, and the interconnection interface 1130 necessary to interconnect parties. And, although the interconnection server 1100 has been spoken of generically, it is clear that one implementation of server 1100 is an Internet website. In accordance with this aspect of the invention, the technique is that of configuring a website, on-demand, to establish and support a voice-like call between parties.

It is possible to further arrange interconnection server 1100 so that, once parties A and B have communicated in the past, their respective sub-spaces may be accessed before any future connection is established. For instance, suppose party A initiates a call to party B, and party B is alerted to the incoming call from party A via caller identification. Before B answers the call, B may, via a data command, access B's sub-space 1150 to review any notes that B may have stored regarding prior conversations with party A. After B has reviewed these notes, then B will typically accept the incoming call from A. Again, upon termination of this present call, the parties may access their sub-spaces to leave notes or review prior messages, as desired.

Although various embodiments which incorporate the teachings of the present invention have been shown and described in detail herein, those skilled in the art can readily devise many other varied embodiments that still incorporate these teachings.

What is claimed is:

1. A method for servicing a dynamically formed group of participants for a temporary social occasion comprising
provisioning a set of computer network-implemented services available from a service provider,
configuring an application to execute on a server accessible to the participants via the service provider, the application being user-created by one of the participants choosing selected ones of the services corresponding to the occasion,
executing the application to interconnect and coordinate the interactions of the participants for the occasion, and
capturing all of the interactions of the participants throughout the duration of the occasion in a thread-of-activity file stored on the server for later recall by at least one of the participants.

2. The method as recited in claim 1 wherein the configuring includes presenting an on-line form via a website provided by the service provider and filling in the form by said one of the participants to choose said selected ones of the services and thereby configure the application.

3. The method as recited in claim 1 wherein one of the services is teleconferencing service and the configuring includes establishing a teleconference call among at least two of the participants.

4. The method as recited in claim 1 wherein the method further includes, after the capturing, deactivating the application to await automatic self-activation of the application at a specified later time with reference to the thread-of-activity file.

5. The method as recited in claim 1 wherein the one of the services is a credit-card charging service and the method further includes charging at least one of the participants for the configuration and execution of the application related to the social occasion.

6. The method as recited in claim 1 wherein the one of the services is a credit-card charging service coupled to an on-line store and the method further includes charging by said store for a gift purchased on-line by at least one of the participants for the social occasion.

7. The method as recited in claim 1 wherein one of the services is purchasing of gifts from an on-line a gift registry established for the social occasion and the method further includes on-line purchasing of a gift by at least one of the participants for another one of the participants.

8. The method as recited in claim 1 wherein the configuring includes configuring the application on-line via a website provided by the service provider and then inviting all of the participants to partake of the social occasion by accessing the website at a time specified by said one of the participants.

9. The method as recited in claim 1 wherein the configuring includes capturing all of the interactions between sub-groups of the participants and saving the sub-group interactions in a sub-group thread-of-activity file on the server.

10. A method for servicing a dynamically formed group of participants for a temporary social occasion comprising
provisioning a set of computer network-implemented services available from a service provider,
configuring an application to execute on a server accessible to the participants via the service provider, the application being user-created by one of the participants choosing selected ones of the services corresponding to the occasion,
executing the application to interconnect and coordinate the interactions of the participants for the occasion,
capturing all of the interactions of the participants throughout the duration of the occasion in a thread-of-activity file stored on the server for later recall by at least one of the participants, and
deactivating the application to await automatic self-activation of the application at a specified later time with reference to the thread-of-activity file.

11. The method as recited in claim 10 wherein the configuring includes presenting an on-line form via a website provided by the service provider and filling in the form by said one of the participants to choose said selected ones of the services and thereby configure the application.

12. The method as recited in claim 10 wherein one of the services is teleconferencing service and the configuring includes establishing a teleconference call among at least two of the participants.

13. The method as recited in claim 10 wherein the method further includes, after the capturing, deactivating the application to await automatic self-activation of the application at a specified later time with reference to the thread-of-activity file.

14. The method as recited in claim 10 wherein the one of the services is a credit-card charging service and the method further includes charging at least one of the participants for the configuration and execution of the application related to the social occasion.

15. The method as recited in claim 10 wherein the one of the services is a credit-card charging service coupled to an on-line store and the method further includes charging by said store for a gift purchased on-line by at least one of the participants for the social occasion.

16. The method as recited in claim 10 wherein one of the services is purchasing of gifts from an on-line a gift registry established for the social occasion and the method further includes on-line purchasing of a gift by at least one of the participants for another one of the participants.

17. The method as recited in claim 10 wherein the configuring includes configuring the application on-line via a website provided by the service provider and then inviting all of the participants to partake of the social occasion by accessing the website at a time specified by said one of the participants.

18. The method as recited in claim 10 wherein the configuring includes capturing all of the interactions between sub-groups of the participants and saving the sub-group interactions in a sub-group thread-of-activity file on the server.

19. A method for servicing a dynamically formed group of participants for a temporary social occasion comprising
provisioning a set of computer network-implemented services available from a service provider,
configuring an application to execute on a server accessible to the participants via the service provider, the application being user-created by one of the participants, distinct from the service provider, choosing selected ones of the services corresponding to the occasion, the server being adapted to execute the occasion-specific services via an on-line website accessible via the service provider,
executing the application to interconnect and coordinate the interactions of the participants for the occasion on the website, and
capturing all of the interactions of the participants throughout the duration of the occasion in a thread-of-activity file stored on the server for later recall by at least one of the participants.

20. The method as recited in claim 19 wherein the configuring includes presenting an on-line form via the website provided by the service provider and filling in the form by said one of the participants to choose said selected ones of the services and thereby configure the application.
